(19) United States
(12) Patent Application Publication
(10) Pub. No.: US 2011/0183004 A1
(43) Pub. Date: Jul. 28, 2011

(54) REPELLING AGENT, BITE REPELLING AGENT AND ARTHROPOD-BORNE DISEASE PREVENTIVE AGENT

(75) Inventors: Hiroyuki Matsuoka, Tochigi (JP); Norio Ogata, Osaka (JP); Takashi Shibata, Osaka (JP)

(73) Assignees: Taiko Pharmaceutical Co. Ltd., Suita-shi, Osaka (JP); Jichi Medical University, Shimotsuke-shi, Tochigi (JP)

(21) Appl. No.: 12/994,458

(22) PCT Filed: May 26, 2009
(86) PCT No.: PCT/JP2009/059609

§ 371 Date: Jan. 25, 2011

(30) Foreign Application Priority Data
May 26, 2008 (JP) 2008-136962

(51) Int. Cl. A01N 59/00; A01P 17/00

(52) U.S. Cl. 424/600

(57) ABSTRACT

The invention provides a measure that can readily prevent arthropod-borne diseases such as malaria that are contracted by 3 to 5 hundred million people worldwide yearly and that cause death of as many as 1.5 to 2.7 million people. By spraying in advance on the skin an arthropod-borne disease preventive agent or the like comprising chlorine dioxide as an effective component thereof, it is possible to provide repelling effect against arthropods such as infected mosquitoes that bear malaria protozoa and also to prevent biting of the skin by the arthropod, thus reducing contraction of the arthropod-borne diseases.

### TECHNICAL FIELD

The present invention relates to a repelling agent, a bite repelling agent, and an arthropod-borne disease preventive agent. More particularly, the invention relates to a repelling agent for repelling arthropods (insects such as mosquito, mite, spider, etc.), a bite repelling agent for preventing bites by arthropods, and a preventive agent for infectious diseases borne by arthropods.

### BACKGROUND ART

Malaria, one of the arthropod-borne diseases (insect-borne diseases), is a disease caused by malaria protozoa borne by Anopheles species of mosquito.

While the disease is less known in Japan due to the small number of people infected by the disease, according to an estimate given by WHO (The World Heath Report), about 3 to 5 hundred millions of people contract the disease worldwide yearly and 1.5 to 2.7 million people die from the disease. So far, regarding malaria, several techniques have been proposed for preventing or treating malaria through oral administration of pharmaceutical agents (e.g. Patent Document 1). In this way, malaria can be treated by anti-malaria agents, but these agents are losing their effectiveness due to the progressive acquisition of drug resistance by the disease-causing protozoa, so in actuality, the situation is deteriorating, rather than ameliorating.

### PRIOR ART DOCUMENT

Patent Document 1: Japanese Patent Application “Kokai” No. 2004-269440

### SUMMARY OF THE INVENTION

### Object to be Achieved by Invention

Human infection of malaria occurs in the following way. At first, a mosquito bites the malaria-infected animal (including humans) and sucks blood of it, whereby the malaria protozoa enters the body of the mosquito and proliferates therein. After a certain period (10 to 12 days), when this infected mosquito bites a human, the malaria protozoa in the body of the mosquito now enters the human body, thus the human becomes infected by malaria. By creating such infection cycle, malaria protozoa has continued to survive. Before a mosquito bites an animal, it inserts its mouth into the skin of the animal and searches the blood vessel. This action is technically called “probing”. In this specification, however, this action will be referred to simply as “bite (or biting)”. Strictly speaking, the “blood sucking” is an action performed after “probing”.

The present inventors have conducted extensive studies seeking a measure to prevent the initial stage of malaria infection, namely, biting by the infected mosquito. As a result, the inventors have discovered that the approaching of mosquitoes as well as the biting by mosquitoes can be effectively prevented by applying aqueous solution of chlorine dioxide on the skin and have perfected the present invention based on this finding.

The object of the present invention is to provide an agent capable of repelling arthropods such as mosquitoes or preventing biting by the arthropod even if it approaches, thus reducing the occurrence of infection of the microorganism.

### Means to Achieve Object

According to the characterizing feature of the repelling agent relating to the present invention, a repelling agent for repelling arthropods comprises chlorine dioxide as an effective component thereof.

With the repelling agent having the above feature, it is possible to keep arthropods such as mosquitoes away from attaching to the skin.

As the characterizing feature of a bite repelling agent relating to the present invention, a repelling agent for preventing a bite by arthropods comprises chlorine dioxide as an effective component thereof.

With the bite repelling agent having the above feature, it is possible to prevent a bite by arthropods such as mosquitoes.

As the first characterizing feature of the agent for preventing arthropod-borne diseases relating to the present invention, an agent for preventing arthropod-borne diseases comprises chlorine dioxide as an effective component thereof.

With the agent for preventing arthropod-borne diseases having the above feature, it is possible to prevent arthropod-borne diseases such as diseases due to the protozoa or the parasite.

As the second characterizing feature of the agent for preventing arthropod-borne diseases relating to the present invention, the arthropod-borne disease is malaria.

With the agent for preventing arthropod-borne diseases having the above feature, it is possible to prevent infection by malaria protozoa.

### MODE OF EMBODYING THE INVENTION

### [Disease-Bearing Arthropods]

As the disease-bearing arthropods in the present invention, there can be cited insects including, but not limited to, the mosquito species such as Anopheles, Culex, Mansonia, and Aedes mosquitoes, the fly species such as Tsetse fly, sandfly, blackfly, cleg, and deer fly, the lice species such as Pediculus humanus, the flea species, the assassin bug species, and the mite species such as Ixodes holocyclus, tsutsugamushi chigger, and argasid.

### [Arthropod-Borne Diseases]

Examples of the arthropod-borne diseases in the present invention include (names in the parentheses are the principal arthropod(s)) malaria (Anopheles mosquito), filariasis (Anopheles, Culex, Mansonia, and Aedes mosquitoes), dengue (Aedes mosquito), yellow fever (Aedes mosquito), Japanese encephalitis (Culex tritaeniorhynchus mosquito), West Nile fever (Culex and Aedes mosquitoes), Leishmaniasis (sandfly), African trypanosomiasis <African sleeping sickness> (Tsetse fly), American trypanosomiasis <Chagas disease> (assassin bug), African eye worm disease (cleg), tularemia (deer fly and tick), typhus (Pediculus humanus corporis), relapsing fever (Pediculus humanus corporis and argasid), plague (fleas parasitic to rats), Lyme disease (tick), R. tsutsugamushi disease (chiggers), tick encephalitis (tick), Japanese spotted fever (ticks). However, the examples are not limited to these.

### [Preparation and Formulations of Chlorine Dioxide Liquid Agent]

Chlorine dioxide can be prepared as a liquid agent, a foaming agent, etc., with a solvent of water or the like and can be used as a spraying agent. Furthermore, in case it is used as an aqueous solution, in order to stabilize the concentration of chlorine dioxide, sodium chlorite (e.g. 1˜20%), phosphate buffer solution (e.g. 1˜20%) (e.g. pH4˜7) can be added thereto. Also, in order to facilitate the wetting spreading of the liquid solution when it is to be applied to the skin, a surfactant agent (e.g. 0.1˜5%) can be added thereto.

Furthermore, in consideration of the readiness of its spraying, liquefied propane gas or the like may be charged into the container as a discharge promoting agent.

As formulations other than a spraying agent, there can be cited formulations prepared by causing a known substrate to contain liquid of chlorine dioxide, thus being rendered into cream-like, gel-like, jelly-like, emulsion-like, paste-like or foam-like form (e.g. ointments, creams, lotions, sprays, liniments, etc.) The substrate used is not particularly limited as long as it is pharmaceutically acceptable. It can be e.g. lower alcohols such as ethanol, isopropanol, etc., triethanolamine, water, beeswax, oils such as jojoba oil, olive oil, cacao oil, sesame oil, soybean oil, avocado oil, camellia oil, peanut oil, polyoxyethylene hydrogenated castor oil, etc., mineral oils such as white petrolatum, liquid paraffin, silicone oils, volatile silicone oils, petrolatum, etc., and higher fatty acids such as lauric acid, myristic acid, stearic acid, oleic acid, etc.

The usage amount thereof cannot be defined in particular, since it varies depending on the environment (temperature, humidity, etc.). However, in general, an agent containing chlorine dioxide by 0.01 ppm to 500 ppm, preferably, 0.1 ppm to 250 ppm, will be used as an appropriate amount, once or from twice to five times a day. The final pH of the liquid chlorine dioxide ranges preferably from 4.5 to 6.5. If the pH value deviates from this range, the storage stability may be reduced, so that there is a possibility of changes in its pharmacological activity during its storage, or the pharmacological activity may become weak after a long-term storage such as for two years. More preferred pH range of the chlorine dioxide agent of the invention is from 5.5 to 6.0.

### EXAMPLES

### Formulation Example 1

### (Formulation of Chlorine Dioxide Aqueous Solution)

A liquid agent of chlorine dioxide was prepared as follows. To 250 mL of water with 2,000 ppm chlorine dioxide gas dissolved therein, 680 mL of water and 80 mL of 25% sodium chlorite solution were added and stirred together. Then, to the resultant mixture solution, sodium dihydrogen phosphate was added by an amount that renders the pH of the solution of 5.5 to 6.0, whereby there was obtained 1,000 mL of chlorine dioxide aqueous solution comprised of dissolved chlorine dioxide gas, sodium chlorite, and sodium dihydrogen phosphate.

### [Assurance of Reproducibility of Invention]

Next, there will be a described result of malaria infection preventing experiment with the use of chlorine dioxide. Before doing so, there will be a described method of obtaining the malaria protozoa and the Anopheles stephensi mosquito and a method of preparing the malaria-infected mosquito.

### <Malaria Protozoa>

Today, as malaria protozoa, there are often employed such species as Plasmodium berghei or P. yoelii, which are available (free of charge) from the Medical Zoology Department of Jichi Medical University (3311-1 Yakushiji, Shimotsuke-shi, Tochigi-ken, Japan). These species are ready to use in a study in a laboratory since they can be infected to mice, but have no infectivity to humans.

Furthermore, it is also possible to use P. falciparum FCR-3 strain (ATCC 30932) and P. falciparum Honduras-1 strain (ATCC 30935) deposited in ATCC (the culture medium will be RPMI 1640 culture medium (pH 7.4) added with 10% human serum, filter-sterilized, and then cultured under the conditions of 5% O₂ concentration, 5% CO₂ concentration, and 90% N₂ concentration, at temperature of 36.5° C.) As these species have infectivity to humans, caution should be taken against biting accident. Also, in the case of infection to mosquitoes, a certain strict containment of experimental environment will be needed that will not allow escape of the mosquitoes therefrom.

### <Anopheles Stephensi Mosquito>

Anopheles stephensi mosquito is now available (free of charge) from the Medical Zoology Department of Jichi Medical University (3311-1 Yakushiji, Shimotsuke-shi, Tochigi-ken, Japan).

<Method of Preparing Infected Mosquitoes>

Malaria infected mosquito can be obtained by causing a mouse (e.g. a Swiss Webster mouse) to be infected with malaria with the use of the above-described malaria protozoa and then causing Anopheles stephensi mosquito to suck blood from this infected mouse. This experimental procedure will be readily performed by those skilled in the art. More particularly, as the basic experimental technique, one should follow the technique by Matsuoka et al., (Matsuoka, H., Yoshida, S., Hirai, M., and Ishii, A. Parasitol. Int. 51. 17-23, 2002), and Arai, et al. (Arai, M., Ishii, A. and Matsuoka, H. Am. J. Trop. Med. Hyg. 70, 139-143, 2004). At first, red blood cells infected with malaria protozoa (2×10⁶) are injected into the abdominal cavity of the mouse. After a lapse of three days, 2˜5% of the red blood cells will be infected with the protozoa. Then, this mouse is anesthetized by intramuscular injection of 0.2 mg of xylazine and 2 g of ketamine. Subsequently, this mouse is subjected to blood suction by female mosquitoes for 30 minutes at 20° C. In this way, infected Anopheles stephensi mosquitoes will be prepared. These mosquitoes are bred with the use of, as a food, a filter paper impregnated with 5% fructose and 0.05% p-aminobenzoic acid at 26° C. in the humidity range from 50˜70% in a room lighted for 14 hours and un-lighted for 10 hours. In this way, mosquitoes infected with malaria will be obtained.

The malaria infected mosquitoes have been successively bred with the use of infected mice in a laboratory of Professor Hiroyuki Matsuoka (present inventor) in an educational foundation: Jichi Medical University (3311-1 Yakushiji, Shimotsuke-shi, Tochigi-ken, Japan). These mosquitoes may be employed only for the purpose of conducting a confirmation experiment on the present invention (limited to the experiment performed within the above laboratory).

### Example 1

Twenty four mice were anesthetized and divided into two groups. That is, 11 mice (mouse Nos. 1˜11) of the 24 mice were used as a control group and water was sprayed over the skins thereof. The remaining thirteen mice (mouse Nos. 21˜33) were used as a chlorine dioxide group and the chlorine dioxide aqueous solution prepared in the Formulation Example 1 was sprayed over the skins thereof. The hair on the backs of the mice were shaved by an electrical shaver for animals, and on these backs, water (control group) or the chlorine dioxide solution were sprayed respectively over an area of 3 cm diameter approximately. In doing this, care should be taken such that the test medical agent solution will be applied uniformly over the skin surface. Also, the level of spraying should be controlled such that the skin surface will be wetted uniformly. Thereafter, each mouse was put on a transparent vessel (tube) (one mouse was put in each tube). In each tube, Anopheles stephensi mosquitoes (introduced September, 1992 from London

Imperial College, then successively bred in Mie University, Jichi University, and Nagasaki University in Japan and used in experiments) infected in advance with malaria (Plasmodium berghei) (introduced September, 1992 from London Imperial College, then has been used in experiments in Mie University, Jichi University, and Nagasaki University in Japan) were released in the rate shown in [Table 1] below, such that the malaria-infected mosquitoes were given opportunity for biting. The infected mosquitoes were put in a 50 mL plastic testing tube, and gauze was placed on the top thereof to fast the mosquitoes for 24 hours in advance. During 15 minute observation period, the number of mosquitoes that bit the mice were counted to provide the result that the biting mosquitoes included 42 out of 88 mosquitoes in the control group (biting rate: 47.7%) and 6 out of 101 mosquitoes in the chlorine dioxide group (biting rate: 5.9%). This difference was statistically significant (risk rate p<0.001). It can be seen that the mosquitoes clearly disliked the mice of the chlorine dioxide group, and did not bite them. The determination of malaria infection was done as follows. After the probing, 0.5 μL of blood was sampled from the tail of each mouse and was placed as a smear on a slide glass, Giemsa-stained, and then subjected to microscopic inspection to find presence/absence of malaria infection.

Separately of the above, chlorine dioxide gas was generated by a conventional method and was bubbled in water, thus 150 ppm (2.2 mM) chlorine dioxide aqueous solution (not containing sodium chlorite or sodium dihydrogen phosphate) was obtained. A similar experiment to the one above was conducted with this solution. The result was found to be substantially same as that with the Formulation Example 1 above (see [Table 1] below).

TABLE 1

| | | | the number | |
|---|---|---|---|---|
| | | | of infected | |
| | | the number | mosquitos | contraction |
| | | of infected | biting (blood | situation of |
| | mouse | mosquitos | sucking) | malaria in |
| | No. | in tube | the mice | the mice |
| comparison | 1 | 10 | 5 | not contracted |
| control group | 2 | 12 | 6 | contracted |
| with spraying | 3 | 12 | 6 | contracted |
| of water to skin | 4 | 12 | 5 | not contracted |
| before biting | 5 | 5 | 3 | not contracted |
| (blood suction) | 6 | 5 | 3 | contracted |
| | 7 | 6 | 2 | contracted |
| | 8 | 6 | 4 | not contracted |
| | 9 | 7 | 3 | contracted |
| | 10 | 6 | 2 | not contracted |
| | 11 | 7 | 3 | contracted |
| | | 88 in total | 42 mosquitos | 6 out of 11 |
| | | | out of 88 bit | contracted malaria |
| | | | the mice | (contraction ratio |
| | | | (biting ratio | 54.5%) |
| | | | 47.7%) | |
| chlorine dioxide | 21 | 12 | 2 | contracted |
| group with | 22 | 12 | 2 | not contracted |
| spraying of | 23 | 12 | 0 | not contracted |
| chlorine dioxide | 24 | 12 | 2 | not contracted |
| aqueous solution | 25 | 5 | 0 | not contracted |
| to skin before | 26 | 5 | 0 | not contracted |
| biting (blood | 27 | 6 | 0 | not contracted |
| suction) | 28 | 6 | 0 | not contracted |
| | 29 | 4 | 0 | not contracted |
| | 30 | 6 | 0 | not contracted |
| | 31 | 7 | 0 | not contracted |
| | 32 | 7 | 0 | not contracted |
| | 33 | 7 | 0 | not contracted |
| | | 101 in total | 6 out of 101 | 1 out of 13 |
| | | | mosquitos | contracted malaria |
| | | | bit the mice | (contraction ratio |
| | | | (biting ratio | 7.7%) |
| | | | 5.9% ) | |

Also, investigation was made about the rate of the mice that were bitten by the malaria-infected mosquitoes and that subsequently contracted malaria. As can be observed from the above [Table 1], of the eleven mice of the control group, six mice contracted malaria (incidence rate: 54.5%). Whereas, as for the chlorine dioxide group mice, only one of the thirteen mice contracted malaria (incidence rate: 7.7%). From this, it is clear that the chlorine dioxide aqueous solution enables prevention of malaria infection.

1. A repelling agent for repelling arthropods comprising chlorine dioxide as an effective component thereof.

2. A bite repelling agent for preventing bite by arthropods comprising chlorine dioxide as an effective component thereof.

3. An agent for preventing arthropod-borne diseases comprising chlorine dioxide as an effective component thereof.

4. The agent for preventing arthropod-borne diseases

3. ng to claim 3, wherein the arthropod-borne disease is malaria.
